(19) United States
(12) Patent Application Publication
(10) Pub. No.: US 2013/0132867 A1
(43) Pub. Date: May 23, 2013

(54) Systems and Methods for Image Navigation Using Zoom Operations

(71) Applicants: Bradley Edward Morris, Raleigh, NC (US); Jordan Riley Benson, Raleigh, NC (US)

(72) Inventors: Bradley Edward Morris, Raleigh, NC (US); Jordan Riley Benson, Raleigh, NC (US)

(21) Appl. No.: 13/467,179

(22) Filed: May 9, 2012

Related U.S. Application Data
(60) Provisional application No. 61/562,108, filed on Nov. 21, 2011.

(51) Int. Cl. G06F 3/048

(52) U.S. Cl. 715/759

(57) ABSTRACT

In accordance with the teachings described herein, systems and methods are provided for navigating an image using zoom operations. A zoomed view of the image may be displayed on a display screen. In response to receiving a first user input, the zoomed view of the image is replaced on the display screen with a zoom selection view of the image, the zoom selection view including a base view of the image with a zoom selection window enclosing a portion of the base view of the image. A second user input may be received to move the zoom selection window in the zoom selection view to identify a portion of the image to be zoomed. A new zoomed view may then be displayed on the display screen, in place of the zoom selection view, that includes the portion of the image identified by the zoom selection window.

### CROSS-REFERENCE TO RELATED APPLICATION

This application claims priority to U.S. Provisional Patent Application No. 61/562,108, titled “Integrated Overview Zoom”, filed on Nov. 21, 2011, the entirety of which is incorporated herein by reference.

### FIELD

The technology described in this patent document relates generally to computer-implemented graphical user interfaces and image processing. More particularly, systems and methods are provided for navigating an image using zoom operations.

### BACKGROUND

Various software applications provide the capability to “zoom in” to magnify portions of a displayed image or to “zoom out” to show a broader view of the displayed image. However, the mechanisms typically provided to control these zoom operations often make it difficult to navigate from one zoomed view of an image to another while maintaining context for the image.

### SUMMARY

In accordance with the teachings described herein, systems and methods are provided for navigating an image using zoom operations. A zoomed view of the image may be displayed on a display screen. In response to receiving a first user input, the zoomed view of the image is replaced on the display screen with a zoom selection view of the image, the zoom selection view including a base view of the image with a zoom selection window enclosing a portion of the base view of the image. A second user input may be received to move the zoom selection window in the zoom selection view to identify a portion of the image to be zoomed. A new zoomed view may then be displayed on the display screen, in place of the zoom selection view, that includes the portion of the image identified by the zoom selection window.

### BRIEF DESCRIPTION OF THE DRAWINGS

FIG. 1 is a block diagram of an example system for navigating an image using zoom operations.

FIG. 2 is a state diagram illustrating an example method for navigating an image using zoom operations.

FIG. 3 is an example of a base view of an image.

FIG. 4 is an example of a cluster of points on a base view that are automatically suggested for zooming.

FIG. 5 is an example of a zoom selection view of an image.

FIG. 6 is an example of a zoomed view of an image.

FIG. 7 is a state diagram of another example method for navigating an image using zoom operations.

FIGS. 8A-10D illustrate examples of several types of image data that may be navigated with zoom operations.

FIG. 11 is a state diagram depicting another example method for navigating an image using zoom operations.

FIGS. 12A-12C depict examples of systems that may be used to optimize the distribution of advertisement information.

### DETAILED DESCRIPTION

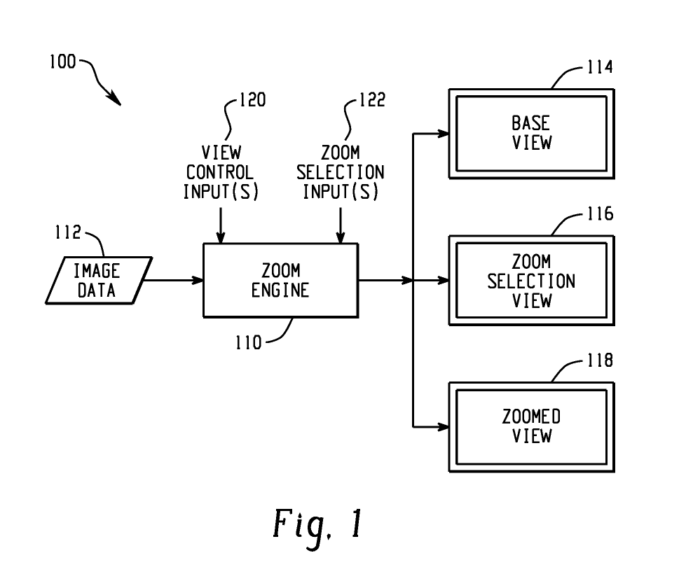

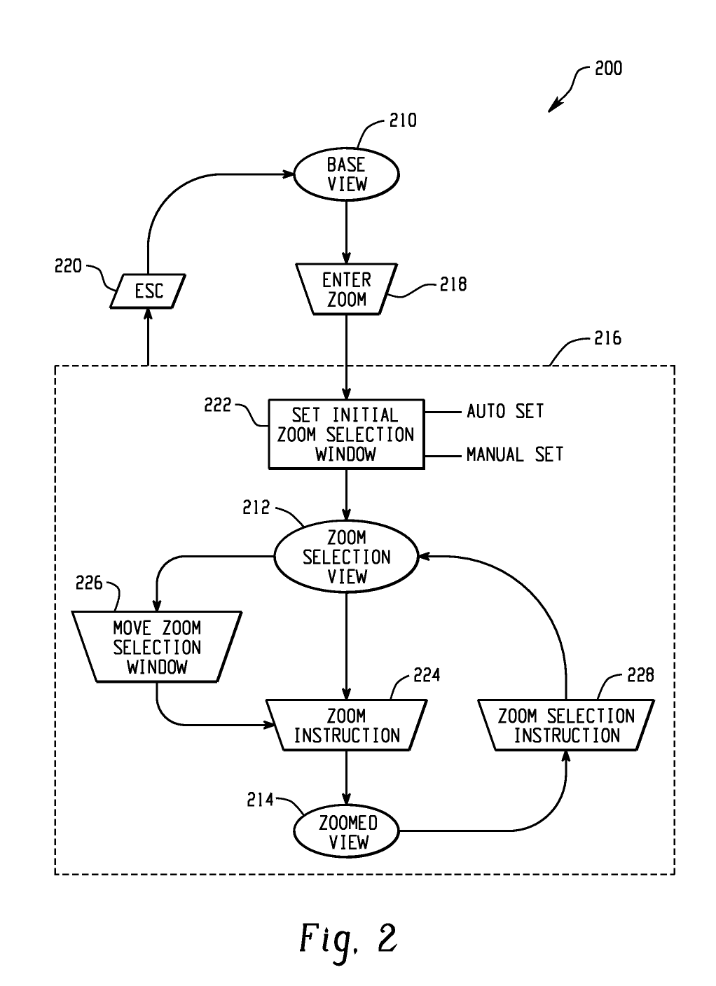

FIG. 1 is a block diagram of an example system 100 for navigating an image using zoom operations. The system 100 includes a zoom engine 110 that receives image data 112 for display and that enables a user to selectively zoom into portions of the displayed image. As used herein, an “image” or “image data” may include any information for display on a screen, such as a graph, a map, a process flow diagram, a graphical user interface, a document, or other displayed data. In certain examples, an “image” or “image data” may include either 2D or 3D data. In addition, an “image” or “image data” may be either static or dynamic. For example, in the case of a static image, such as a photograph, zooming in on a portion of the image will reveal a magnified view of the zoomed portion. In the case of a dynamic image, however, zooming may reveal attributes of the data that were not included in the zoomed out view. For instance, zooming in on a portion of a graph may reveal additional points on the graph that were not included in a zoomed out view of the graph.

In operation, the zoom engine 110 causes the image data 112 to be displayed on a viewing screen in one of a plurality of view modes 114, 116, 118 based on one or more user inputs 120, 122. In the illustrated example 100, the zoom engine 110 receives one or more view control inputs 120 that cause the image data 112 to be displayed in either a base view 114, a zoom selection view 116 or a zoomed view 118. In the base view 114, the image data 112 is displayed with a predefined amount of zoom. For instance, the base view 114 may be a display of the image at 100% zoom (i.e., with no magnification or reduction.) In another example, the base view 114 may be a fully zoomed-out display of the image, e.g., with the full image being displayed on the screen.

The zoom selection view 116 includes the base view 114 of the image with an overlaid zoom selection window that encloses a portion of the displayed image. The zoom selection window may be manipulated based on one or more zoom selection inputs 122 to select a portion of the base view 114 to be zoomed. The zoom selection input(s) 122 may, for example, be used to move and/or resize the zoom selection window within the zoom selection view 116.

The zoomed view 118 includes a magnified view of the portion of the image data 112 selected in the zoom selection view 116. The zoomed view 118 may, for example, be displayed by the zoom engine 110 upon receiving a view control input 120 from within the zoom selection view 118.

The zoom engine 110 enables a user to switch between the view modes 114, 116, 118 based on the zoom selection input(s) 122. The different view modes 114, 116, 118 may, for example, be displayed on the same screen area of a display device such that only a single one of the view modes 114, 116, 118 is displayed at any given time. The zoom selection input(s) 112 may provide a user-friendly way of switching between view modes 114, 116, 118, such that the user may toggle between different modes 114, 116, 118 to easily change the zoomed area of the image. In this way, the user is provided with a convenient way of navigating the image while utilizing the available screen area for each of the viewing modes 114, 116, 118, which may be particularly advantageous for devices with smaller viewports, such as a smart phone or tablet computer.

The zoom engine 110 shown in FIG. 1 may, for example, be implemented by software instructions that are stored in one or more computer-readable mediums and are executed by one or more processors to control the display on the image data 112 on a display device. For instance, the zoom engine 110 may be included in a desktop, laptop or tablet computer, in a handheld computing device such as a PDA or smart phone, or in some other type of computing device.

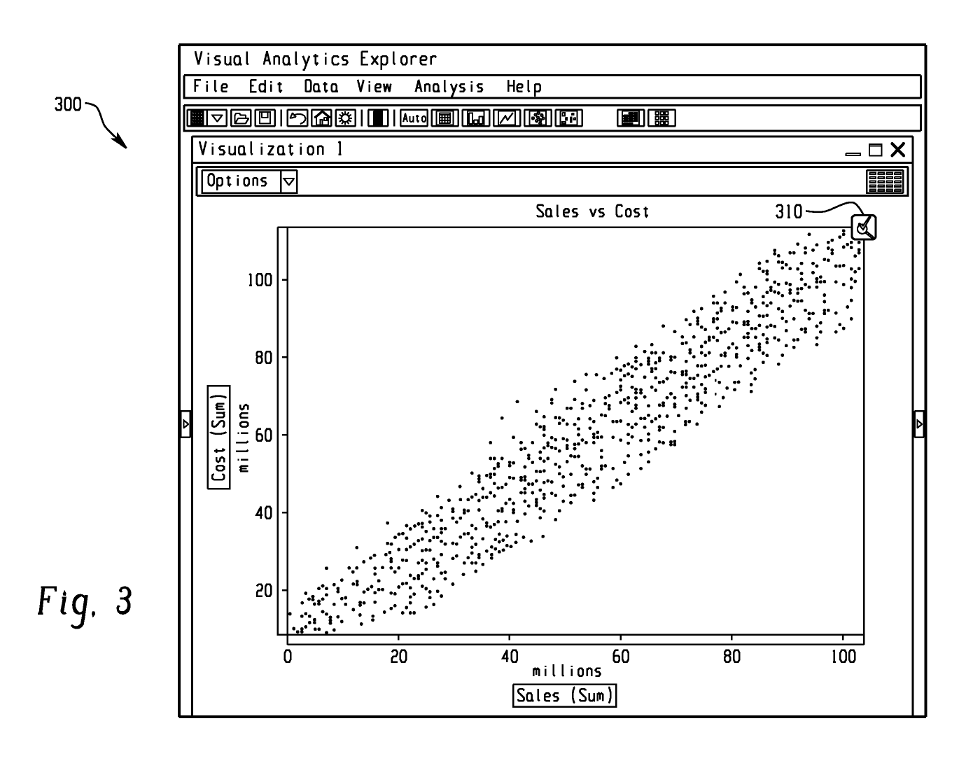

FIG. 2 is a state diagram illustrating an example method 200 for navigating an image using zoom operations. The method 200 illustrated in FIG. 2 may, for example, be implemented by the zoom engine 110 of FIG. 1. The example illustrated in FIG. 2 includes three states for displaying image data: a base view 210, a zoom select view 212 and a zoomed view 214. Examples of the base view 210, zoom select view 212 and zoomed view 214 are described below with reference to FIGS. 3-6. From the base view 210, the method 200 enters a zoom mode 216 upon receiving a zoom input 218. The method 200 may exit the zoom mode 216, returning to the base view 210, upon receiving an escape input 220

Upon entering the zoom mode 216, parameters for an initial zoom selection window are established at 222. The initial zoom selection parameters may, for example, define an initial size and/or placement of the zoom selection window within the zoom select view 212. As illustrated, the parameters for the initial zoom selection window may be set based on manual or automatic configuration settings. For example, a user may manually define and store one or more default zoom selection window parameters that are implemented upon entering zoom mode 216. In other examples, the initial parameters for the zoom selection window may be automatically established based on one or more factors, such as a selection state triggered by data brushing, or by statistical analyses used to find clusters, peaks, outliers or other points of interest in the image data. Once the initial zoom selection parameters are established, the method enters the zoom selection view 212.

From the zoom selection view 212, the method may receive a zoom instruction 224 that causes the portion of the base image enclosed in the zoom selection window to be magnified in the zoomed view 214. In addition, the zoom selection window may be moved and/or resized 224 from within the zoom selection view to enclose a different portion of the base view for magnification in the zoomed view 214. From within the zoomed view 214, a zoom selection instruction 228 may be received causing the method to return to the zoom selection view 212.

The inputs 218, 220, 224, 226, 228 illustrated in FIG. 2 may, for example, be user inputs received from one or more user input devices (e.g., by selecting a zoom key, pressing a mouse button or dragging a mouse), from selecting a graphical input on a graphical user interface (e.g., a graphical icon or scroll bar), or from some other input device or application. In addition, it should be understood that similar to the other processing flows described herein, one or more of the steps and the order in the flowchart shown in FIG. 2 may be altered, deleted, modified and/or augmented and still achieve the desired outcome.

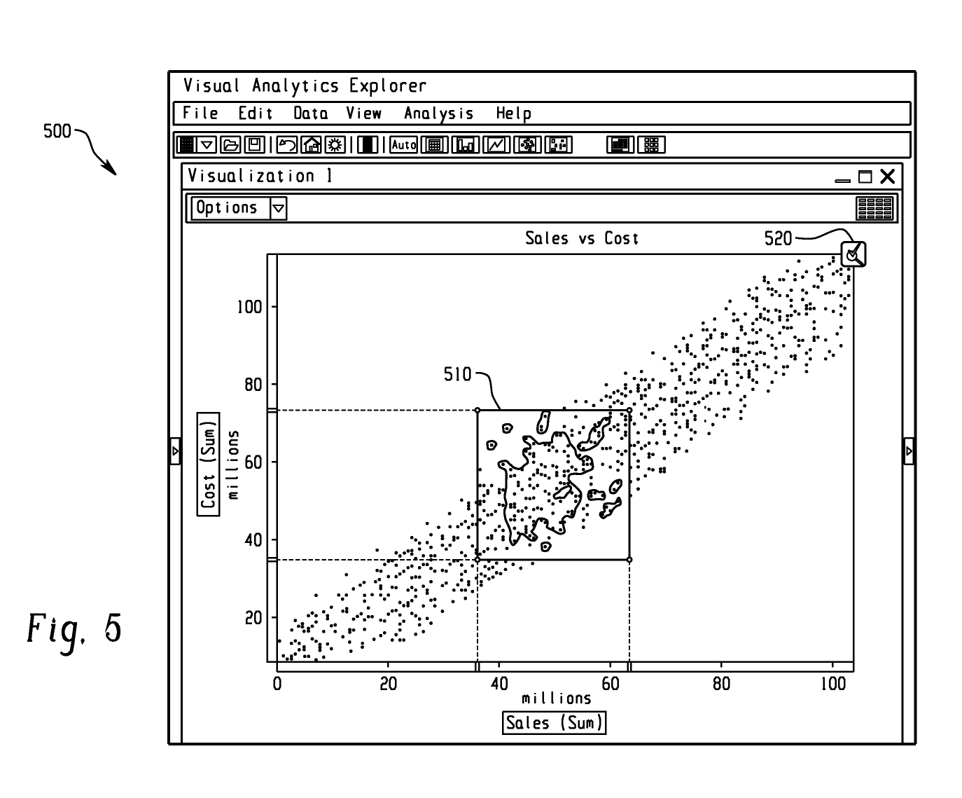

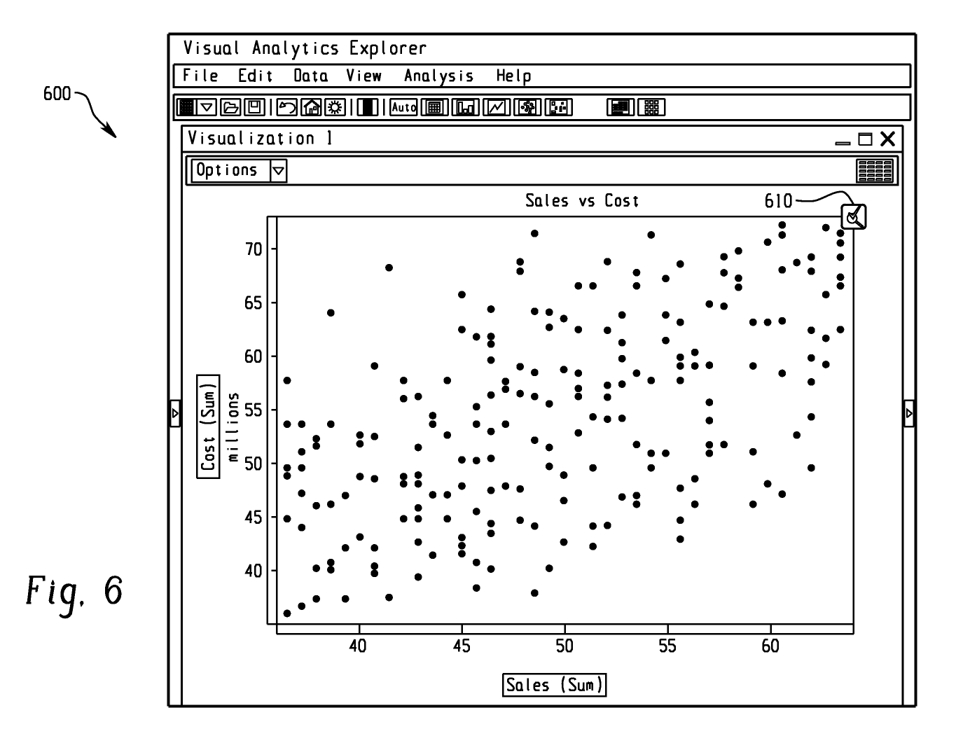

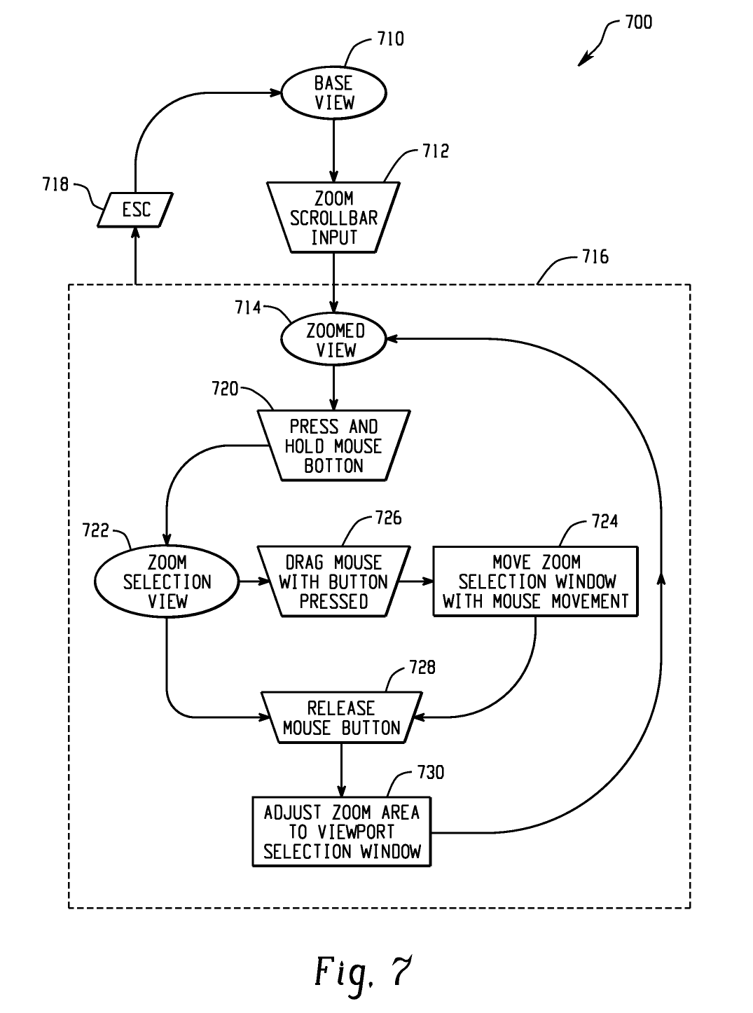

To help illustrate the method of FIG. 2 an example is set forth at FIGS. 3-6. FIG. 3 is an example 300 of a base view of an image. In the example of FIG. 3, the base view 300 is a fully zoomed-out view that displays all data points on a graph 300. As shown, the base view 300 may include a graphical icon 310 for receiving a user input to enter zoom mode. Selecting the zoom mode icon 310 may, for example, cause the application to replace the base view of the graph with a zoom selection view, as shown in FIG. 5. In one alternative example, selection of the zoom mode icon 310 may cause the application to replace the base view with a zoomed view (e.g., as shown in FIG. 6), automatically zooming in on some predetermined or previously zoomed portion of the base view.

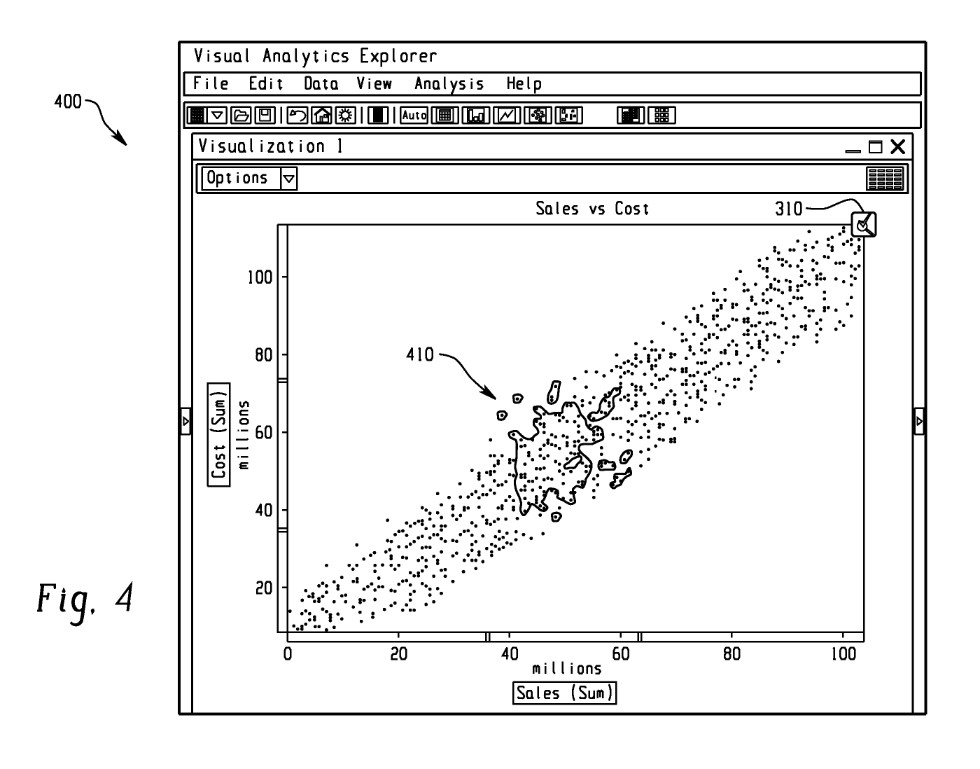

Prior to entering the zoom selection view or the zoomed view from the base view, the application may be configured to intelligently suggest a portion of the image to be zoomed based on some characteristic of the displayed information. For example, FIG. 4 illustrates a cluster of points 410 on a base view 400 of a graph that have been suggested for zooming based on some criteria, such as one or more filtering parameters, a selection state triggered by data brushing, or by statistical analysis used to find clusters, peaks, outliers, or other points of interest. For instance, in the illustrated example, the selected cluster of points 410 may have been identified through a data brushing process in which the cluster of points 410 is selected based on equivalent observations which were selected in a separate graph showing a different view of the same data. For instance, the second graph could be displaying different attributes of the data which are not plotted on the graph being zoomed. Similarly, the selection could be driven by a data selection UI in which conditions are set on specific attributes and the observations that meet the criteria are selected (e.g., using an instruction such as “where VARIABLE A less than 500 AND VARIABLE A greater than 100”). In other examples, a portion of an image may be suggested for zoom using other methods or criteria, such as a learning algorithm that observes areas the user tends to zoom on over time, a historical record of the last zoom state that a user of the particular display was viewing, an eye tracker that generates hotspot data to pick the region the user has been looking at most intently, formatting employed by the user such as highlighting or color-coding to indicate data in the image of particular interest, or some other suitable means of identifying an area of interest.

If the suggested portion of the image is selected for zooming (e.g., by selecting the zoom icon 310), then the application may transition to the zoom selection view (e.g., as shown in FIG. 5) with the size and position of the zoom selection window being automatically determined to bound the selected elements 410 in the base view 400 of the image. Alternatively, selecting the zoom icon 310 with selected elements 410 identified in the base view 400 may cause the application to automatically transition to a zoomed view (e.g., as shown in FIG. 6) that is centered on the selected elements 410.

An example of a zoom selection view 500 is illustrated in FIG. 5. In the example of FIG. 5, the base view from FIG. 3 is displayed with a zoom selection window 510 enclosing a portion of the image to be zoomed. In order to modify the portion of the image to be zoomed, the user may alter the dimensions and/or position of the zoom selection window. For instance, a graphical interface to the zoom selection view 500 may enable the user to select and drag an edge or corner of the zoom selection window 510 to modify its dimensions. In addition, the graphical interface 500 may enable the user to select and drag the entire zoom selection window 510 to reposition the window over a different portion of the base image. In addition, the graphical interface to the zoom selection view 500 may utilize one or more characteristics of the underlying image data as a basis for resizing or repositioning the zoom selection window. For instance, in the illustrated example, the graphical interface 500 may enable the user to modify the dimensions of the view selection window 510 by selecting a data range on each axis of the graph.

In another example, a graphical interface to the zoom selection view 500 may impose one or more restrictions on how the zoom selection window 510 may be modified. For instance, in the case of a bar graph, the zoom selection view 500 may automatically keep the zoom selection window 510 aligned with the baseline and prevent scaling of the response axis.

From the zoom selection view 500, a user input may be received to transition to a zoomed view of the portion of the base image enclosed in the zoom selection window 510. For instance, in the illustrated example a user may select a graphical icon 520 from the zoom selection view 500 to transition to the zoomed view. A graphical interface to the zoom selection view 500 may also provide the user with an input to return to the base view 400.

An example of a zoomed view 600 is illustrated in FIG. 6. Specifically, the zoomed image 600 shown in FIG. 6 is a magnified view of the portion of the base image enclosed in the zoom selection window 510 shown in FIG. 5. From the zoomed view 600, the system may receive inputs to return to either the zoom selection view (e.g., as shown in FIG. 5) or to the base view (e.g., as shown in FIG. 3). For instance, in the illustrated example, a graphical icon 610 is provided to cause the application to transition to the zoom selection view. Another graphical input (not shown) may also be available to transition from the zoomed view 600 to the base view.

As illustrated in the examples shown in FIGS. 3-6, transitioning between the different views 400, 500, 600 of the image data causes the selected view to be displayed in the same display region of the graphical interface. That is, a selected view replaces the previously displayed view in the display region, as opposed to two or more different views being simultaneously displayed in different display regions or on different displays. With the addition of a user friendly mechanism for transitioning between views, the user is provided with an effective way to navigate the image data while maximizing the available display area for each view. In addition, transitioning between different views in the same display area enables the user to keep focus on the data area instead of diverting their attention to a separate display region. This enables the user to easily navigate large data visualizations by transitioning back and forth between a zoomed view and a zoom selection view without shifting focus away from the component.

In certain embodiments, the system and method may provide a user friendly series of inputs to enable a user to quickly transition back and forth between the zoom selection view and the zoomed view. One such embodiment is illustrated in FIG. 7, which depicts a state diagram of another example method 700 for navigating an image using zoom operations. In this example, the base view 710 provides a scrollbar input 712 to select a magnification level and to cause the method to transition from the base view 710 to the zoomed view 714. The method 700 may then exit zoom mode 716, returning to the base view 710, upon receiving an escape input 718.

From the zoom view 714, the user may press and hold a mouse button (at 720) to transition to the zoom selection view 722. The method 700 will remain in the zoom selection view 722 as long as the mouse button remains pressed. While in zoom selection view 722, the user may move the zoom selection window (at 724) by dragging the mouse (at 726) while the mouse button remains pressed. Once the mouse button is released (at 728), the area to be zoomed is modified (at 730) to account for any repositioning of the zoom selection window, and the method 700 returns to the zoomed view 714.

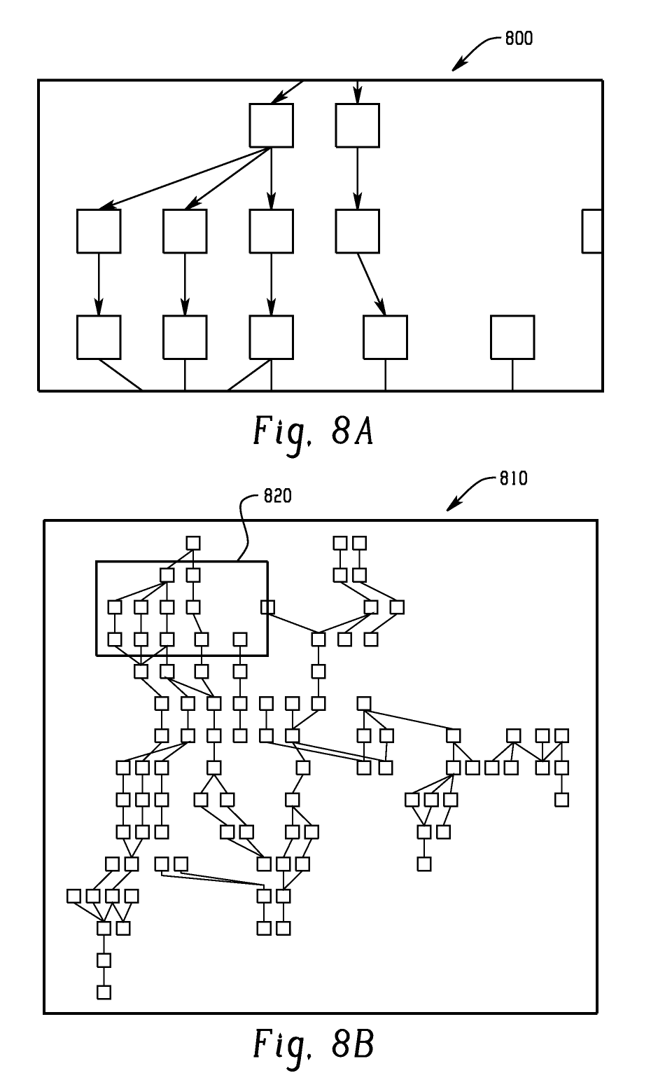

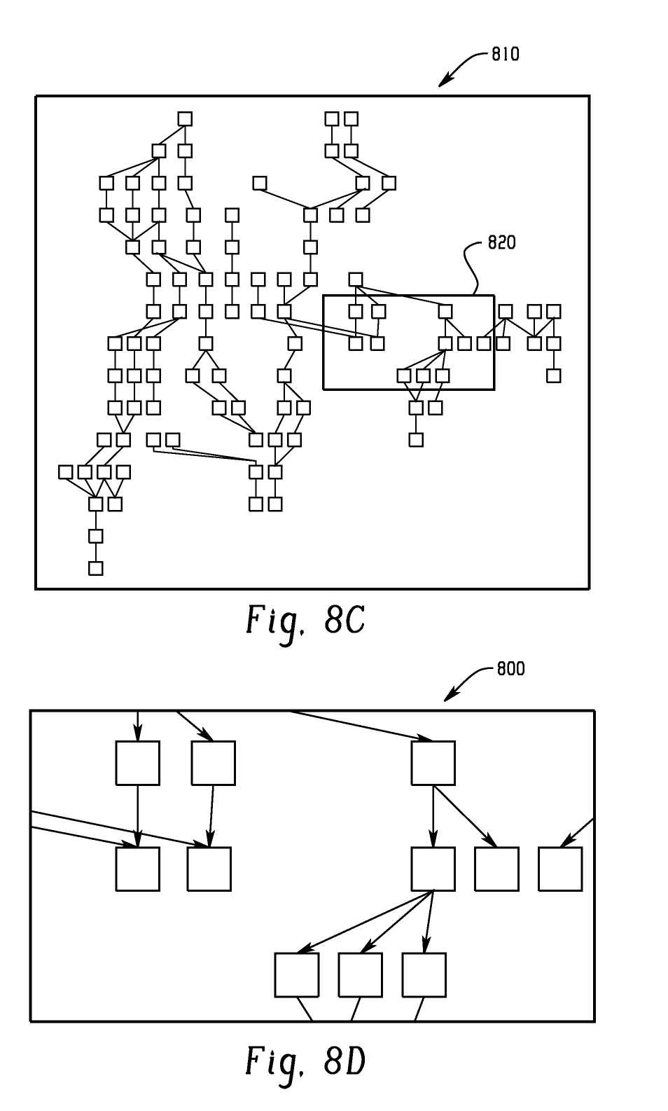

FIGS. 8A-10D illustrate examples of several types of image data that may be navigated with zoom operations using the systems and methods described herein. With reference first to FIGS. 8A-8D, these figures illustrate an example of using zoom operations to navigate a process flow diagram. FIG. 8A depicts a zoomed view 800 of a portion of the process flow diagram. By selecting an input from the zoomed view 800 (e.g., by pressing an holding a mouse button), the user may transition from the zoomed view 800 to a zoom selection view 810, as shown in FIG. 8B. Upon entering the zoom selection view 810, the zoom selection window 820 is positioned to enclose the portion of the process flow diagram from the previous zoomed view 800. From within the zoom selection view 810, the user may select a new portion of the process flow diagram to be zoomed, as shown in FIG. 8C. The user may then transition back to the zoomed view 800 (e.g., by releasing the mouse button), as shown in FIG. 8D, to display a magnification of the newly selected portion of the process flow diagram.

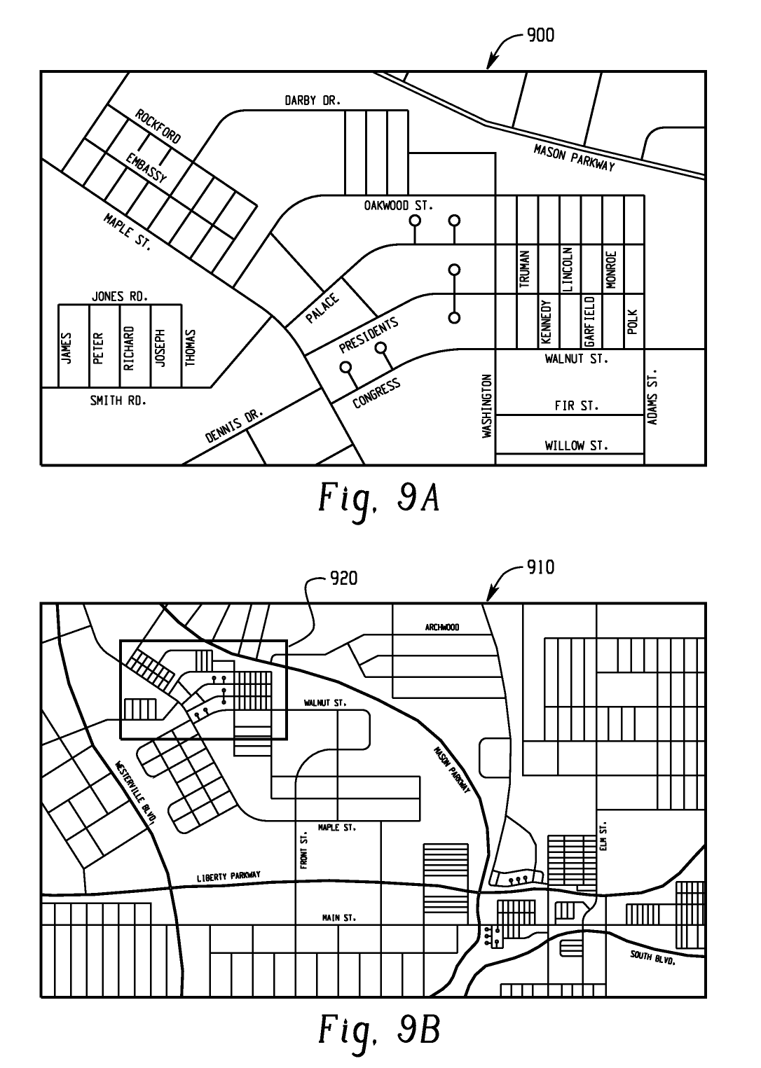

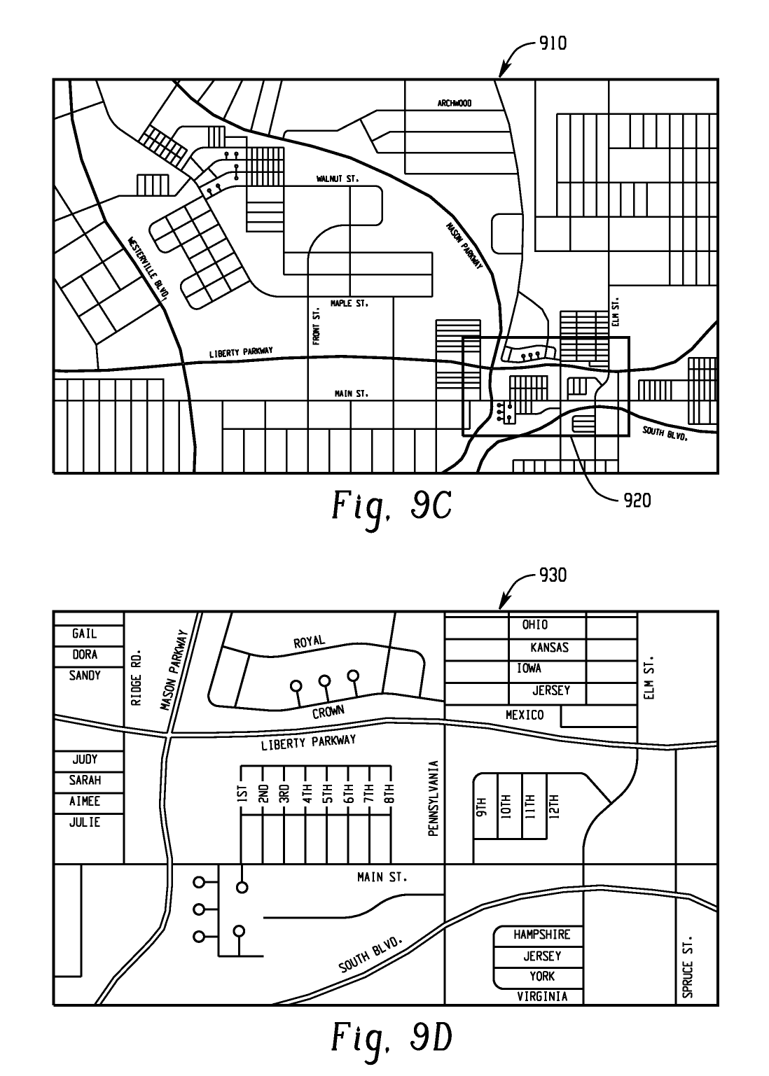

FIGS. 9A-9D illustrate an example of using zoom operations to navigate a map. FIG. 9A illustrates a first zoomed view 900 of a portion of the map. Upon receiving a user input from the first zoomed view 900, a zoom selection view 910 is displayed that includes a base view of the map and a zoom selection window 920 enclosing the previously zoomed portion of the map, as shown in FIG. 9B. The zoom selection window 920 may then be repositioned to enclose another portion of the map, as shown in FIG. 9C. Upon receiving a user input from the zoom selection view 910, a second zoomed view 930 is displayed that includes the newly selected portion of the map, as shown in FIG. 9D

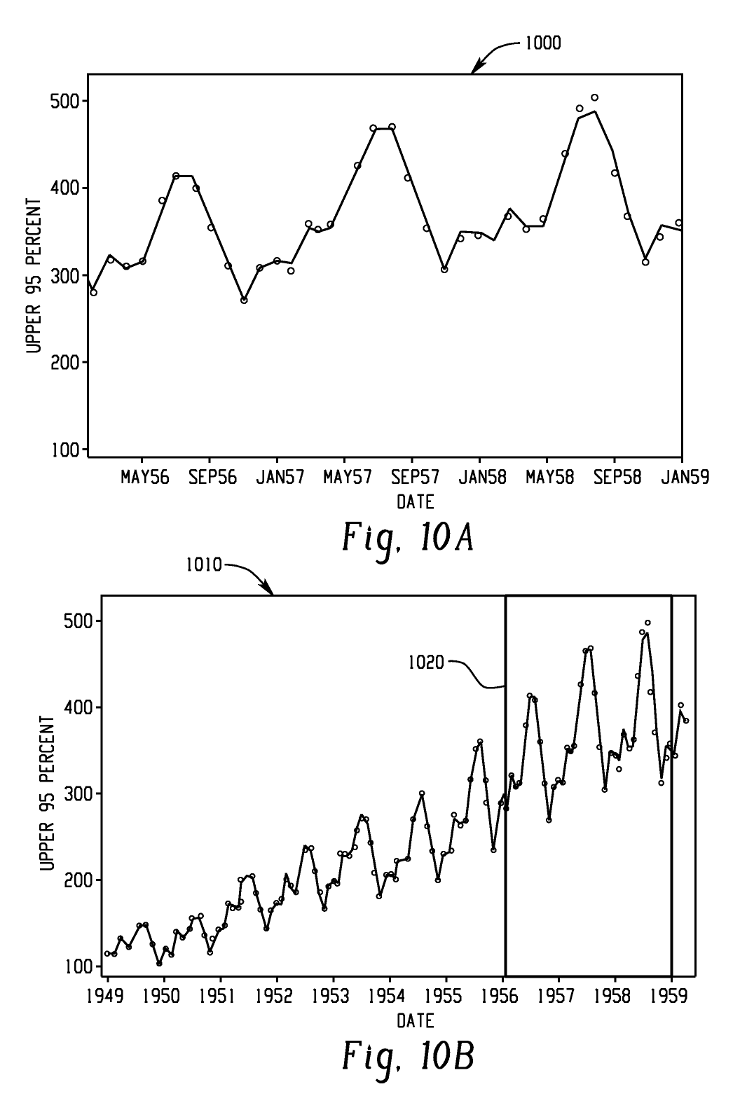

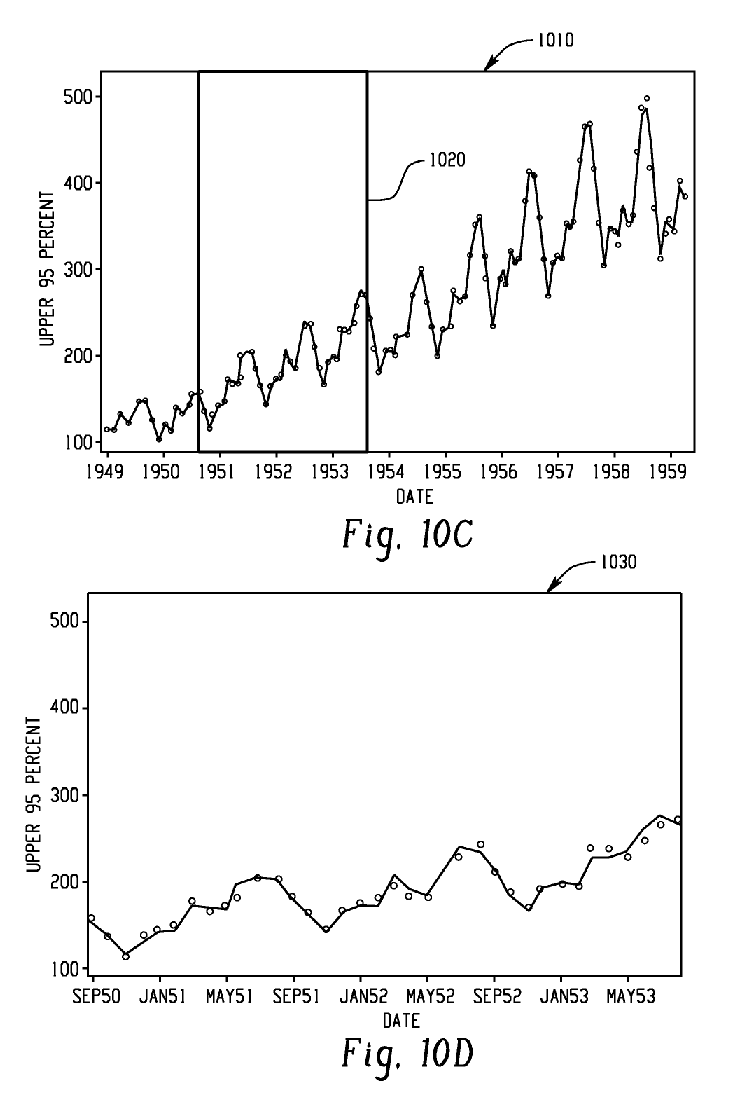

FIGS. 10A-10D illustrate an example of using zoom operations to navigate a graph. FIG. 10A illustrates a zoomed view 1000 of a first portion of the graph. Upon receiving a user input from the zoomed view 1000, a zoom selection view 1010 is displayed, as shown in FIG. 10B, that includes a base view of the entire graph and a zoom selection window 1020 enclosing the previously zoomed portion of the graph. In this example, the zoom selection window 1020 may be repositioned along the horizontal axis of the graph in order to enclose a different range of data for zooming, as shown in FIG. 10C. Upon receiving a user input from the zoom selection view 1010, a zoomed view 1030 is displayed, as shown in FIG. 10D, that includes a magnification of the newly selected range of data from the graph.

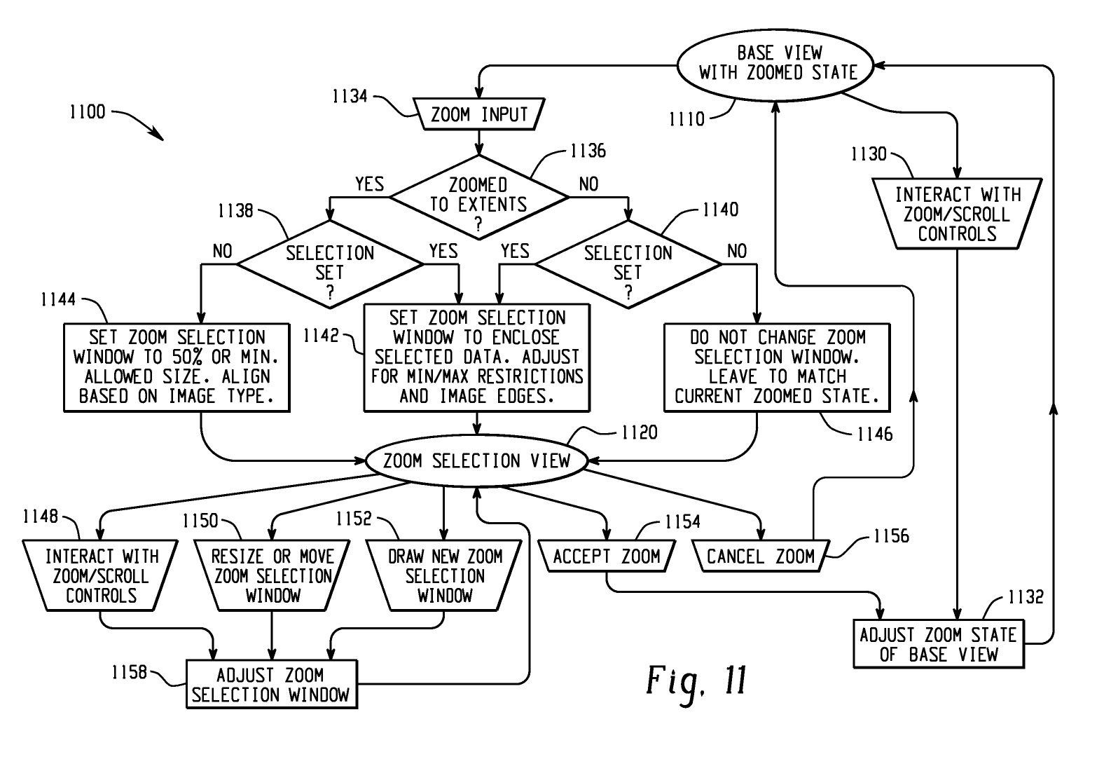

FIG. 11 is a state diagram depicting another example method 1100 for navigating an image using zoom operations. In this example, the method combines the previously described base and zoomed views into a base view having a zoomed state 1110. This recognizes that the base view of the image, as described above with reference to other example embodiments, may be treated as a zoomed view with a preset amount of magnification or reduction (e.g., fully zoomed out). In this way, the system and method may be simplified to include only two states: a base view with a zoomed state 1110 and a zoom selection view 1120.

From the base view 1110, the user may interact with a zoom control input (at 1130), such as a graphical zoom scroll bar, to adjust the zoom level of the base view (at 1132). As shown, in this example the zoom level may be adjusted directly from the base view 1110 without entering the zoom selection view 1120. However, to provide more control over the portion of the base image to be zoomed, the user may also enter the zoom selection view 1120 by selecting a second zoom input at 1134. The second zoom input 1134 may, for example, be selected by pressing and holding a mouse button, selecting a graphical icon, pressing a specialized zoom key, or by some other suitable input mechanism.

Upon receiving the zoom input 1134, the method determines at 1136 whether the base view 1110 is currently fully zoomed to its extends. In other words, the method determines if the base view 1110 is currently in a zoomed state. If the base view is zoomed to extents (i.e., not currently magnified), then the method proceeds to 1138. Otherwise, if the base view is currently zoomed, the method proceeds to 1140.

At either 1138 or 1140, the method determines if any of the image data has been selected or suggested for zooming. For instance, as described above with reference to FIG. 4, portions of the image data may be automatically suggested for zooming based on some criteria, such as one or more filtering parameters, a selection state triggered by data brushing, or by statistical analysis used to find clusters, peaks, outliers, or other points of interest. In another example, one or more portions of the image data may be manually selected to be included in the zoomed image. If any portion of the image data has been selected or suggested for zooming, then the method proceeds from either 1138 or 1140 to 1142. At 1142, the method sets the size and/or position of the zoom selection window to enclose any portions of the image data that have been selected for inclusion in the zoomed image. In addition, the method may also adjust the boundaries of the zoom selection window to account for any preset restrictions on the size and position of the zoom selection window.

If no particular image data has been selected for zooming, then the method proceeds either from 1138 to 1144 (if zoomed to extents) or from 1140 to 1146 (if already zoomed). If the base view is already zoomed, then the zoom selection window is left to enclose the currently zoomed portion of the image data at 1146. If the base view is zoomed to extents, then, at 1144, the zoom selection window is set to a predetermined size and position, for example based on the type of image. For instance, the zoom selection window may be set to 50% of its maximum size or to a predetermined minimum size. The zoom selection window may also be positioned based on the type of image. For example, if the image is a graph on an x-y axis, then the zoom selection window may be initially aligned with its left-most edge along the y axis. As a default, the method may, for example, align the zoom selection window at the center of the base view.

Once the size and position of the zoom selection window is set at 1142, 1144 or 1146, the zoom selection view 1120 is displayed. From the zoom selection view, the user may either adjust the size and/or position of the zoom selection window (at 1148, 1150 or 1152), accept the size and position of the zoom selection window for zooming (at 1154), or escape out of the zoom selection view (at 1156) and return to the base view 1110.

At 1148, the user may interact with a zoom control input, such as a zoom scroll bar, to increase or decrease the amount of magnification inside of the zoom selection window. At 1150, the user may resize and/or reposition the zoom selection window, for example by selecting and dragging an edge or corner of the window or moving the entire window to a new position on the base image. At 1152, the user may draw a new zoom selection window to replace the currently displayed window. For example, a user interface may enable the user to draw a box on the displayed base image that replaces the current zoom selection window. Any adjustments made to the zoom selection window at 1148, 1150, or 1152 are implemented at 1158 so that the adjusted zoom selection window is displayed in the zoom selection view 1120.

Once the user is satisfied with the size and position of the zoom selection window, a zoom input may be entered at 1154, causing the zoom state of the base image to be adjusted at 1132 to zoom in on the portion of the image enclosed in the zoom selection window.

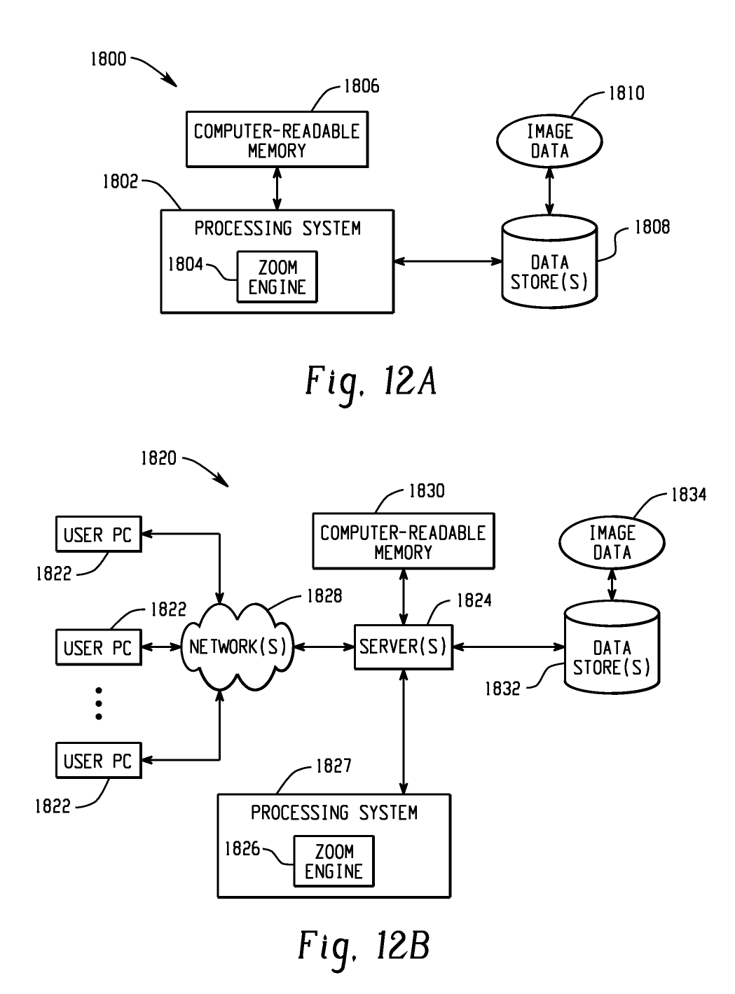

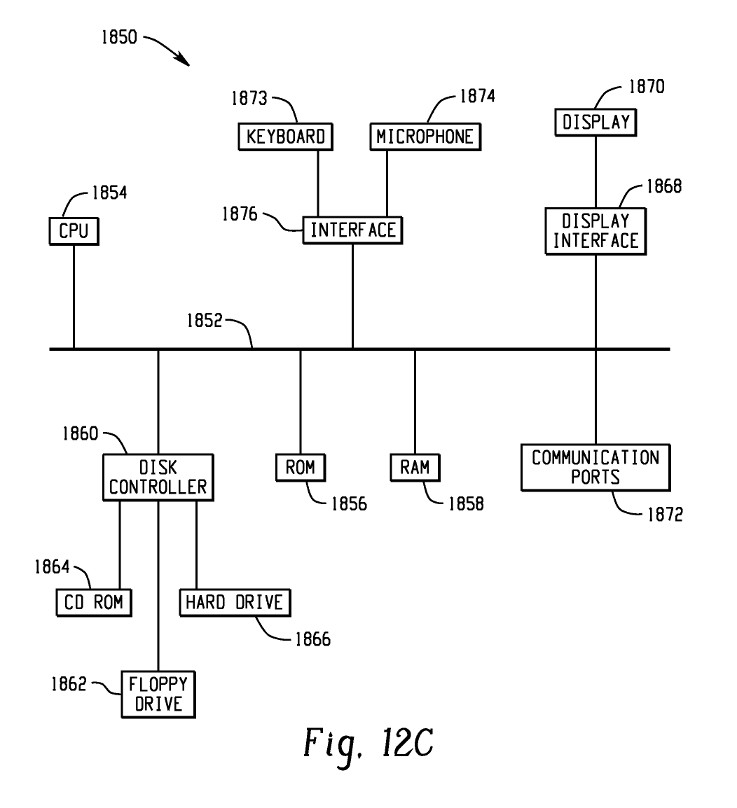

FIGS. 12A, 12B, and 12C depict examples of systems that may be used to navigate an image using zoom operations. For example, FIG. 12A depicts an example of a system 1800 that includes a standalone computer architecture where a processing system 1802 (e.g., one or more computer processors) includes a zoom engine 1804 being executed on it. The processing system 1802 has access to a computer-readable memory 1806 in addition to one or more data stores 1808. The one or more data stores 1808 may include image data 1810 to be processed and displayed by the zoom engine 1804.

FIG. 12B depicts a system 1820 that includes a client server architecture. One or more user PCs 1822 access one or more servers 1824 running a zoom engine program 1826 on a processing system 1827 via one or more networks 1828. The one or more servers 1824 may access a computer readable memory 1830 as well as one or more data stores 1832. The one or more data stores 1832 may contain image data 1834 that is processed and displayed by the zoom engine 1826.

FIG. 12C shows a block diagram of an example of hardware for a standalone computer architecture 1850, such as the architecture depicted in FIG. 12A that may be used to contain and/or implement the program instructions of system embodiments of the present invention. A bus 1852 may connect the other illustrated components of the hardware. A processing system 1854 labeled CPU (central processing unit) (e.g., one or more computer processors), may perform calculations and logic operations required to execute a program. A processor-readable storage medium, such as read only memory (ROM) 1856 and random access memory (RAM) 1858, may be in communication with the processing system 1854 and may contain one or more programming instructions for navigating an image using zoom operations. Optionally, program instructions may be stored on a computer readable storage medium such as a magnetic disk, optical disk, recordable memory device, flash memory, or other physical storage medium.

A disk controller 1860 may interface one or more disk drives to the system bus 1852. These disk drives may be external or internal floppy disk drives such as 1862, external or internal CD-ROM, CD-R, CD-RW or DVD drives such as 1864, or external or internal hard drives 1866.

Each of the element managers, real-time data buffer, conveyors, file input processor, database index shared access memory loader, reference data buffer and data managers may include a software application stored in one or more of the disk drives connected to the disk controller 1860, the ROM 1856 and/or the RAM 1858. Preferably, the processor 1854 may access each component as required.

A display interface 1868 may permit information from the bus 1852 to be displayed on a display 1870 in audio, graphic, or alphanumeric format. Communication with external devices may occur using various communication ports 1872.

In addition to the standard computer-type components, the hardware may also include data input devices, such as a keyboard 1873, or other input device 1874, such as a microphone, remote control, pointer, mouse and/or joystick.

This written description uses examples to disclose the invention, including the best mode, and also to enable a person skilled in the art to make and use the invention. The patentable scope of the invention may include other examples. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

It is claimed:

1. A computer-implemented method for navigating an image using zoom operations, comprising:
displaying a zoomed view of the image on a display screen;
receiving a first user input;
in response to the first user input, replacing the zoomed view of the image on the display screen with a zoom selection view of the image, the zoom selection view including a base view of the image with a zoom selection window enclosing a portion of the base view of the image;
receiving a second user input to move the zoom selection window in the zoom selection view to identify a portion of the image to be zoomed; and
displaying on the display screen, in place of the zoom selection view, a new zoomed view of the image that includes the portion of the image identified by the zoom selection window;
wherein the steps of the computer-implemented method are performed by one or more processors.

2. The computer-implemented method of claim 1, further comprising:
receiving a third user input, wherein the new zoomed view of the image is displayed in response to the third user input.

3. The computer-implemented method of claim 2, wherein:
the first user input includes pressing a mouse button;
the second user input includes a mouse drag; and
the third user input includes releasing the mouse button.

4. The computer-implemented method of claim 1, further comprising:
displaying the base view of the image on the display screen;
receiving an initial user input; and
replacing the base view of the image with the zoom selection view of the image in response to the initial user input.

5. The computer-implemented method of claim 4, wherein an initial location of the zoom selection window is automatically selected based at least in part on a statistical analysis of the image to identify one or more likely points of interest in the image.

6. The computer-implemented method of claim 5, wherein the one or more likely points of interest include one or more of clusters, peaks or outliers in the image.

7. The computer-implemented method of claim 4, wherein an initial location of the zoom selection window is automatically selected based at least in part on one or more filtering parameters.

8. The computer-implemented method of claim 4, wherein an initial location of the zoom selection window is automatically selected based at least in part on a selection state triggered by data brushing.

9. The computer-implemented method of claim 1, further comprising:
displaying the base view of the image on the display screen;
receiving an initial user input; and
replacing the base view of the image with an initial zoomed view of the image in response to the initial user input.

10. The computer-implemented method of claim 9, wherein a portion of the base image included in the initial zoomed view is automatically selected based at least in part on a statistical analysis of the image to identify one or more likely points of interest in the image.

11. The computer-implemented method of claim 10, wherein the one or more likely points of interest include one or more of clusters, peaks or outliers in the image.

12. The computer-implemented method of claim 9, wherein a portion of the base image included in the initial zoomed view is automatically selected based at least in part on one or more filtering parameters.

13. The computer-implemented method of claim 9, wherein a portion of the base image included in the initial zoomed view is automatically selected based at least in part on a selection state triggered by data brushing.

14. The computer-implemented method of claim 1, wherein the image is a graph, a map, or a process flow diagram.

15. The computer-implemented method of claim 1, wherein the image is a graph and the second user input corresponds to one or more data ranges in the graph.

16. A system for navigating an image using zoom operations, comprising:
a display; and
a zoom engine stored in one or more computer-readable mediums and executable by one or more processors, when executed the zoom engine being configured to,
display a zoomed view of the image on the display screen,
receive a first user input,
in response to the first user input, replace the zoomed view of the image on the display screen with a zoom selection view of the image, the zoom selection view including a base view of the image with a zoom selection window enclosing a portion of the base view of the image,
receive a second user input to move the zoom selection window in the zoom selection view to identify a portion of the image to be zoomed, and
display on the display screen, in place of the zoom selection view, a new zoomed view of the image that includes the portion of the image identified by the zoom selection window.

17. The system of claim 16, wherein the zoom engine is further configured to receive a third user input, wherein the new zoomed view of the image is displayed in response to the third user input.

18. The system of claim 17, wherein:
the first user input includes pressing a mouse button;
the second user input includes a mouse drag; and
the third user input includes releasing the mouse button.

19. The system of claim 16, wherein the zoom engine is further configured to:
display the base view of the image on the display screen;
receive an initial user input; and
replace the base view of the image with the zoom selection view of the image in response to the initial user input.

20. The system of claim 19, wherein an initial location of the zoom selection window is automatically selected based at least in part on a statistical analysis of the image to identify one or more likely points of interest in the image.

21. The system of claim 20, wherein the one or more likely points of interest include one or more of clusters, peaks or outliers in the image.

22. The system of claim 19, wherein an initial location of the zoom selection window is automatically selected based at least in part on one or more filtering parameters.

23. The system of claim 19, wherein an initial location of the zoom selection window is automatically selected based at least in part on a selection state triggered by data brushing.

24. The system of claim 16, wherein the zoom engine is further configured to:
display the base view of the image on the display screen;
receive an initial user input; and
replace the base view of the image with an initial zoomed view of the image in response to the initial user input.

25. The system of claim 24, wherein a portion of the base image included in the initial zoomed view is automatically selected based at least in part on a statistical analysis of the image to identify one or more likely points of interest in the image.

26. The system of claim 25, wherein the one or more likely points of interest include one or more of clusters, peaks or outliers in the image.

27. The system of claim 25, wherein a portion of the base image included in the initial zoomed view is automatically selected based at least in part on one or more filtering parameters.

28. The system of claim 25, wherein a portion of the base image included in the initial zoomed view is automatically selected based at least in part on a selection state triggered by data brushing.

29. The system of claim 16, wherein the image is a graph, a map, or a process flow diagram.

30. The system of claim 16, wherein the image is a graph and the second user input corresponds to one or more data ranges in the graph.
